(19) United States
(12) Patent Application Publication
(10) Pub. No.: US 2010/0098951 A1
(43) Pub. Date: Apr. 22, 2010

(54) BLACK ADHESION PROMOTER COMPOSITION AND ITS DETECTION

(75) Inventors: Reto Fassler, Zurich (CH); Wolf-Rudiger Huck, Zurich (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/312,670

(22) PCT Filed: Nov. 30, 2007
(86) PCT No.: PCT/EP2007/063045

§ 371 Date: Dec. 2, 2009

(30) Foreign Application Priority Data
Nov. 30, 2006 (EP) 06125150.0
Aug. 6, 2007 (CH) 01242/07

(51) Int. Cl. B32B 17/06; C09K 11/06; C09K 11/02; B32B 37/12; G01N 23/22

(52) U.S. Cl. 428/426; 252/301.16; 252/301.35; 156/314; 250/362

(57) ABSTRACT

The present invention relates to adhesion promoter compositions having at least one adhesion promoter substance, at least one black pigment and at least one luminescent substance. The adhesion promoter compositions can be located and identified easily by irradiation with UV light and analysis of the radiation which is emitted, and are therefore highly suited to use in automated operations, more particularly in the context of glazing a vehicle.

### TECHNICAL FIELD

The invention relates to the field of adhesion promoter compositions filled with black pigments and to the use thereof as undercoats for adhesives and sealants.

### STATE OF THE ART

Adhesion promoter compositions have been used for some time to improve the adhesion of an adhesive or sealant on a substrate.

Firstly, unfilled adhesion promoter compositions, also referred to as clear primers, are used for this purpose. However, such clear compositions are difficult to see. WO 2006/065798 A1, WO 03/106579 A1 and US 2006/0089292 A1 disclose such unfilled compositions to which a luminescent substance has been added.

Secondly, filled, especially carbon black-filled, adhesion promoter compositions are used. Carbon black-filled adhesion promoter compositions are also referred to as black primers. The black color of the carbon black, which is a black pigment, or of the carbon black-filled adhesion promoter compositions arises from the fact that it substantially absorbs light over the entire visible range. However, the use of a black adhesion promoter composition on a black substrate is very critical since it can be recognized only with very great difficulty, if at all, whether and/or where such a black adhesion promoter composition has been applied or not. Since the adhesion promoter composition plays an essential role for the quality of an adhesive bond, this uncertainty is associated with high risk.

### SUMMARY OF THE INVENTION

The object of the present invention is therefore to provide adhesion promoter compositions which comprise black pigments which can be detected, or identified, on a black substrate.

It has now been found that, surprisingly, this object is achieved by an adhesion promoter composition as claimed in claim 1.

Even small concentrations of luminescent substance can lead to the result that such an adhesion promoter composition can be detected reliably in a simple manner and a subsequent adhesive bond of high quality can be ensured as a result.

The adhesion promoter compositions find use as undercoats for adhesives and/or sealants.

The present invention further relates to a method for detecting an adhesion promoter composition as claimed in claim 19, to a method for adhesive bonding as claimed in claim 13, to a resulting article as claimed in claim 17 and to a substrate coated with an adhesion promoter composition as claimed in claim 11.

Further particularly preferred embodiments of the invention are the subject matter of the dependent claims.

### WAYS OF PERFORMING THE INVENTION

The present invention relates to an adhesion promoter composition which comprises at least one adhesion-promoting substance, at least one black pigment and at least one luminescent substance.

The adhesion promoter composition comprises an adhesion-promoting substance, also referred to hereinafter as adhesion promoter. The adhesion promoter is preferably selected from the group consisting of organosilicon compounds, organotitanium compounds, organozirconium compounds, polyepoxides, polyisocyanates, isocyanate-containing polymers and mixtures thereof.

Substance names beginning with “poly”, for example polyisocyanate, polyurethane, polyol, polyepoxide, polyamine, polysulfide, refer in the present document to substances which, in a formal sense, contain two or more of the functional groups which occur in their name per molecule.

In the present document, the term “polymer” firstly embraces a collective of macromolecules which are chemically homogeneous but differ in relation to degree of polymerization, molar mass and chain length, which has been prepared by a poly reaction (polymerization, polyaddition, polycondensation). The term secondly also embraces derivatives of such a collective of macromolecules from poly reactions, i.e. compounds which have been obtained by reactions, for example additions or substitutions, of functional groups onto given macromolecules, and which may be chemically homogeneous or chemically inhomogeneous. The term further also embraces so-called prepolymers, i.e. reactive oligomeric preadducts whose functional groups are involved in the formation of macromolecules.

The term “polyurethane polymer” embraces all polymers which are prepared by what is known as the diisocyanate polyaddition process. This also includes those polymers which are virtually or entirely free of urethane groups. Examples of polyurethane polymers are polyetherpolyurethanes, polyesterpolyurethanes, polyetherpolyureas, polyureas, polyesterpolyureas, polyisocyanates and polycarbodiimides.

The organosilicon compound here has at least one hydroxyl group, alkoxy group or acyloxy group bonded to a silicon atom, and at least one organic substituent bonded to a silicon atom via a carbon-silicon bond. The organotitanium compound here has at least one substituent bonded to the titanium atom via an oxygen-titanium bond. The organozirconium compound here has at least one substituent bonded to the zirconium atom via an oxygen-zirconium bond.

Particularly suitable organosilicon compounds are organosilicon compounds of the formulae (I) or (II) or (III) or (IV).

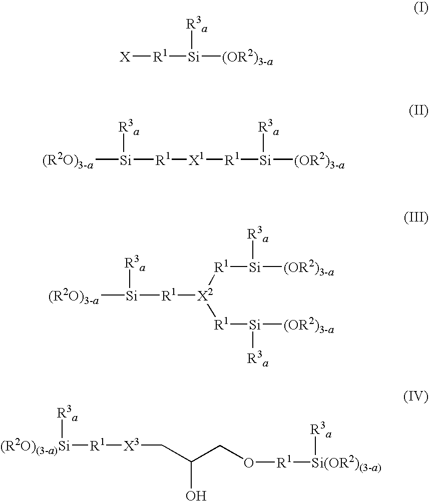

R¹ here is a linear or branched, cyclic or acyclic, alkylene group having 1 to 20 carbon atoms, optionally with aromatic components, and optionally with one or more heteroatoms, especially nitrogen atoms.

R² here is H or an alkyl group having 1 to 5 carbon atoms, especially methyl or ethyl, or an acyl group, especially acetyl.

R³ here is an alkyl group having 1 to 8 carbon atoms, especially methyl.

X here is H, or is a functional group selected from the group comprising oxirane, OH, (meth)acryloyloxy, amine, SH, acylthio and vinyl, preferably amine. For the sake of completeness, it is mentioned that acylthio in this document is understood to mean the substituent

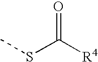

where R⁴ is alkyl, especially having 1 to 20 carbon atoms, and the dotted line represents the bond to the substituent R¹.

X¹ here is a functional group selected from the group comprising NH, S, S₂ and S₄.

X² here is a functional group selected from the group comprising N and isocyanurate.

X³ here is a functional group selected from the group of S and NR⁵ where R⁵ is H, alkyl, cycloalkyl, aryl or a radical of the formula —Si(R³)ₐ(OR²)₍₃₋ₐ₎. These alkyl, cycloalkyl or aryl R⁵ radicals preferably each have 1 to 10 carbon atoms.

a here is one of the values 0, 1 or 2, preferably 0.

The substituent R¹ is especially a methylene, propylene, methylpropylene, butylene or dimethylbutylene group. Particular preference is given to using the propylene group as the substituent R¹.

Organosilicon compounds having amino, mercapto or oxirane groups are also referred to as “aminosilanes”, “mercaptosilanes” or “epoxysilanes”.

Examples of suitable organosilicon compounds of the formula (I) are the organosilicon compounds selected from the group comprising octyltrimethoxysilane, dodecyltrimethoxysilane, hexadecyltrimethoxysilane, methyloctyldimethoxysilane; 3-glycidyloxypropyltrimethoxysilane, 3-glycidyloxypropyltriethoxysilane; 3-methacryloyloxypropyltrialkoxysilane, 3-methacryloyloxypropyltriethoxysilane, 3-methacryloyloxypropyltrimethoxysilane; 3-aminopropyltrimethoxysilane, 3-aminopropyltriethoxysilane, 3-aminopropyldimethoxymethylsilane, 3-amino-2-methylpropyltrimethoxysilane, N-(2-amino-ethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, [3-(2-aminoethylamino)propyl]trimethoxysilane (=4,7,10-triazadecyltrimethoxysilane), 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane; 3-mercaptopropyltriethoxysilane, 3-mercaptopropyltrimethoxysilane, 3-mercaptopropylmethyldimethoxysilane; 3-acylthiopropyltrimethoxysilane; vinyltrimethoxysilane and vinyltriethoxysilane.

Also preferred are the organosilicon compounds just mentioned, whose alkoxy groups are replaced by acetoxy groups, for example octyltriacetoxysilane (octyl-Si(O(O═C)CH₃)₃). Such organosilicon compounds eliminate acetic acid when hydrolyzed.

Among these organosilicon compounds mentioned, preference is given to those which have an organic substituent which is bonded to the silicon atom and which additionally also has a functional group, i.e. which is not an alkyl group, and corresponds to a formula (I) in which X is not H.

Examples of suitable organosilicon compounds of the formula (II) are the organosilicon compounds selected from the group comprising bis[3-(trimethoxysilyl)propyl]amine, bis[3-(triethoxysilyl)propyl]amine, 4,4,15,15-tetraethoxy-3,16-dioxa-8,9,10,11-tetrathia-4-15-disilaoctadecane, bis(triethoxysilylpropyl) polysulfide or bis(triethoxysilylpropyl) tetrasulfane, bis(triethoxysilylpropyl) disulfide.

Examples of suitable organosilicon compounds of the formula (III) are the organosilicon compounds selected from the group comprising tris[3-(trimethoxysilyl)propyl]amine, tris[3-(triethoxysilyl)propyl]amine, 1,3,5-tris[3-(trimethoxysilyl)propyl]-1,3,5-triazine-2,4,6(1H,3H,5H)-trioneurea (=tris(3-(trimethoxysilyl)propyl)isocyanurate) and 1,3,5-tris[3-(triethoxysilyl)propyl]-1,3,5-triazine-2,4,6(1H,3H,5H)-trioneurea (=tris(3-(triethoxysilyl)propyl) isocyanurate).

Suitable organosilicon compounds of the formula (IV) are especially the reaction products of 3-mercaptopropyltrimethoxysilane or 3-aminopropyltrimethoxysilane or bis[3-(trimethoxysilyl)propyl]amine with 3-g lycidyloxypropyltrimethoxysilane. Preferentially suitable are the reaction products of 3-aminopropyltrimethoxysilane and 3-glycidyloxypropyltrimethoxysilane. Organosilicon compounds of the formula (IV) are also understood to mean intramolecular cyclic transesterification products.

Preferred organosilicon compounds are aminosilanes, especially aminosilanes where X=NH₂ or NH₂—CH₂—CH₂—NH, X¹=NH and X²=N. Particular preference is given to 3-aminopropyltrimethoxysilane, N-(2-amino-ethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane and bis[3-(triethoxysilyl)propyl]amine, and also mixtures thereof.

Substituents particularly suitable as substituents bonded to the titanium atom via an oxygen-titanium bond are those selected from the group comprising alkoxy group, sulfonate group, carboxylate group, dialkyl phosphate group, dialkyl pyrophosphate group and acetylacetonate group.

Particularly suitable compounds are those in which all substituents bonded to the titanium are selected from the group comprising alkoxy group, sulfonate group, carboxylate group, dialkyl phosphate group, dialkyl pyrophosphate group and acetylacetonate group, where all substituents may be identical or different from one another.

Particularly suitable alkoxy groups have been found to be especially what are known as neoalkoxy substituents, especially of the following formula (V).

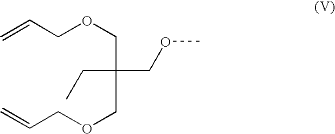

Particularly suitable sulfonic acids have been found to be especially aromatic sulfonic acids whose aromatic rings are substituted by an alkyl group. Preferred sulfonic acids are considered to be radicals of the following formula (VI).

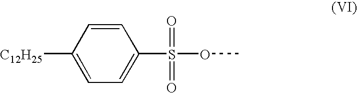

Particularly suitable carboxylate groups have been found to be especially carboxylates of fatty acids. A preferred carboxylate is decanoate.

In the above formulae, the dotted line represents the bond of the oxygen to the titanium.

Organotitanium compounds are commercially available, for example from Kenrich Petrochemicals or DuPont. Examples of suitable organotitanium compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or Tyzor® ET, TPT, NPT, BTM, AA, AA-75, AA-95, AA-105, TE, ETAM, OGT from DuPont.

Preference is given to Ken-React® KR 7, KR 9S, KR 12, KR 26S, KR 38S, KR44, LICA 09, LICA 44, NZ 44, and Tyzor® ET, TPT, NPT, BTM, AA, AA-75, AA-95, AA-105, TE, ETAM from DuPont.

Particular preference is given to organotitanium compounds which contain substituents of the formulae (V) and/or (VI) bonded to the titanium atom via an oxygen-titanium bond.

Suitable organozirconium compounds are especially those which bear at least one functional group selected from the group comprising alkoxy group, sulfonate group, carboxylate group, phosphate or mixtures thereof, and which is bonded directly to a zirconium atom via an oxygen-zirconium bond.

Particularly suitable alkoxy groups have been found to be especially isopropoxy and what are known as neoalkoxy substituents, especially of the formula (V).

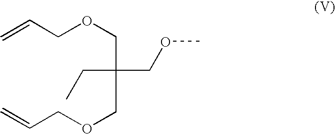

Particularly suitable sulfonic acids have been found to be especially aromatic sulfonic acids whose aromatic rings are substituted by an alkyl group. Preferred sulfonic acids are radicals of the formula (VI).

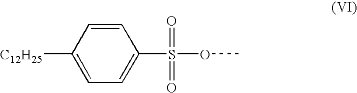

Particularly suitable carboxylate groups have been found to be especially carboxylates of fatty acids. Preferred carboxylates are stearates and isostearates.

In the above formulae, the dotted line represents the bond of the oxygen to the zirconium.

Organozirconium compounds are commercially available, for example from Kenrich Petrochemicals. Suitable organozirconium compounds are, for example, Ken-React® NZ 38J, NZ TPPJ, KZ OPPR, KZ TPP, NZ 01, NZ 09, NZ 12, NZ38, NZ 44, NZ 97.

It is clear to the person skilled in the art that these organosilicon compounds, organotitanium compounds and organozirconium compounds are hydrolyzed under the influence of water and form OH groups bonded to the silicon, titanium or zirconium atom. Such hydrolyzed or partly hydrolyzed organosilicon compounds, organotitanium compounds and organozirconium compounds may then in turn be condensed and form condensation products which have Si—O—Si, Ti—O—Ti, Zr—O—Zr bonds. When silanes and/or titanates and/or zirconates as adhesion promoters are mixed, mixed condensation products which have Si—O—Ti, Si—O—Zr or Ti—O—Zr bonds are also possible. A small proportion of such condensation products is possible, especially when they are soluble, emulsifiable or dispersible.

The adhesion promoter composition preferably comprises at least one organosilicon compound. In certain cases, a combination of organosilicon compounds and organotitanium compounds is particularly preferred.

Suitable polyisocyanates are especially diisocyanates or triisocyanates. Preference is given to commercially available polyisocyanates, for example hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, lysine diisocyanate and lysine ester diisocyanate, cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydro diphenylmethane 2,4′- and 4,4′-diisocyanate (HMDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3- and 1,4-diisocyanate (m- and p-TMXDI), bis(1-isocyanato-1-methylethyl)naphthalene, tolylene 2,4- and 2,6-diisocyanate and any desired mixtures of these isomers (TDI), diphenylmethane 4,4′-, 2,4′- and 2,2′-diisocyanate and any desired mixtures of these isomers (MDI), phenylene 1,3- and 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), and any desired mixtures of the aforementioned isocyanates and the biurets thereof or the isocyanurates thereof. Particular preference is given to MDI, TDI, HDI and IPDI, and the biurets or isocyanurates thereof.

Polymers containing isocyanate groups can be obtained especially from the polyisocyanates just mentioned and the polyols and/or polyamines mentioned further down in a known manner.

The proportion of the adhesion-promoting substance is 1-80% by weight, especially 5-70% by weight, preferably 10-40% by weight, of the overall composition. When the adhesion-promoting substance is an organosilicon compound or an organotitanium compound, the proportion of the adhesion-promoting substance in the overall composition is preferably 1-15% by weight.

The adhesion promoter composition further comprises at least one black pigment. Black pigments are known to those skilled in the art and are described, for example, in Herbst, W., Hunger, K., Industrielle Organische Pigmente [Industrial Organic Pigments] (VCH Verlag, 2nd edition, 1995) on pages 482-496, 583-584 and 640, and in Endriss, H., Aktuelle anorganische Bunt-Pigmente [Modern-day Inorganic Color Pigments], (Vincentz Verlag, 1997) on pages 45-54. Preference is given to black pigments which, in the Color Index published by the Society of Dyers and Colourists, bear the name “Colour Index Pigment Black” or “C.I. Pigment Black”.

The black pigment present in the adhesion promoter composition is preferably selected from the group consisting of carbon black, iron oxide black, chromium iron black, iron manganese copper oxide, aniline black, anthraquinone pigments and perylene pigments. Especially preferred are industrially produced carbon black, iron oxide black and aniline black. Carbon black is most preferred. The proportion of the black pigment, especially carbon black, in the adhesion promoter composition is 0.1-15% by weight, especially 1-15% by weight, preferably >5-15% by weight, more preferably 6-15% by weight, most preferably 6-10% by weight, of the overall composition.

The adhesion promoter composition according to the above description preferably comprises a combined proportion of adhesion-promoting substance and black pigment, especially carbon black, of 10% by weight, especially 15-70% by weight, preferably 25-60% by weight, of the overall composition.

The adhesion promoter composition further comprises at least one luminescent substance. Suitable luminescent substances are those which, on irradiation with radiation of a particular wavelength, emit radiation of different wavelength, especially those which luminesce on irradiation with UV radiation, preferably those which luminesce with radiation of a wavelength between 240 and 400 nm on irradiation. The person skilled in the art is aware of many luminescent substances. Such luminescent substances are described, for example, in “11 Kirk-Othmer Encyclopedia of Chemical Technology” (John Wiley & Sons, 4th Ed., 1994) on pages 227-241.

Especially suitable are substances which are commercially available under the trademarks Uvitex® from Ciba Specialty Chemicals, Lumilux® from Riedel-de Haen GmbH, Blankophor® from Bayer Chemicals and Ultraphor® from BASF. Preference is given to Uvitex® OB (Ciba Specialty Chemicals).

If the adhesion promoter composition comprises water, especially suitable luminescent substances are those obtainable under the trademarks Uvitex® NFW, Uvitex® BFA, Uvitex® MST or Tinopal® from Ciba Specialty Chemicals, and Pyranin® from Bayer Chemicals.

The individual luminescent substances have characteristic emission wavelengths on irradiation with radiation of a particular wavelength. The emission wavelength may thus be an important selection criterion for the luminescent substance.

The amount of luminescent substance present in the adhesion promoter composition is preferably in the range between 0.01-5% by weight, especially 0.1-3% by weight, preferably 0.2-1% by weight, based on the weight of the overall composition. The amount of luminescent substance, based on the weight of the overall composition, is more preferably within a range of 0.1-5% by weight.

The content of luminescent substance also depends on the content of the black pigment in the adhesion promoter composition. The higher the content of the black pigment, the trend is to preferentially use a higher content of luminescent substance in the adhesion promoter composition.

The adhesion promoter composition more preferably has a content of black pigment, especially carbon black, between 6 and 10% by weight, and a content of luminescent substance between 0.1 and 5% by weight, based in each case on the weight of the overall composition.

In one embodiment, the adhesion promoter composition additionally comprises at least one high molecular weight polymer as a film former.

These film formers serve the purpose of film formation on the surface of the adhesion promoter composition. This film strengthens the adhesion promoter composition and can simultaneously protect the coated substrate from undesired environmental influences.

The film former may have functional groups which can react with the surface of the coated substrate and/or with the adhesive or sealant applied later and/or within the adhesion promoter composition. For example, such functional groups are hydroxyl, carboxyl, isocyanate, mercapto, epoxy or alkoxysilane groups, and combinations thereof. More particularly, these functional groups are hydroxyl, carboxyl, isocyanate, epoxy or alkoxysilane groups, or combinations thereof. Preferred functional groups are isocyanate or epoxy or alkoxysilane groups.

It will be clearly apparent to a person skilled in the art that the film former should not have any functional groups which, in the absence of moisture, react with one another or with other constituents of the adhesion promoter composition, especially of the adhesion-promoting substances, since there would otherwise be premature crosslinking.

As film formers are especially polymers selected from a group consisting of poly(meth)acrylates, polyurethanes, polyepoxides, polyesters, alkoxysilane-terminated polymers and polymers containing isocyanate groups. Preference is given to poly(meth)acrylates, alkoxysilane-terminated polymers and/or polymers containing isocyanate groups.

The high molecular weight polymers used as film formers preferably have a mean molecular weight of 5000 g/mol or more, especially 10 000 g/mol or more, preferably 15 000 g/mol or more. The high molecular weight polymers preferably have a mean molecular weight of 200 000 g/mol or less, especially 150 000 g/mol or less, preferably 100 000 g/mol or less.

In a preferred embodiment, the adhesion promoter composition additionally comprises at least one solvent. The solvents used are especially alcohols, ethers, ketones, esters or hydrocarbons, preferably isopropanol, ethanol, methyl ethyl ketone, acetone, hexane, heptane, xylene, toluene or acetates, especially ethyl acetate or butyl acetate. In addition, water or mixtures of water with the alcohols, ethers, ketones, esters or hydrocarbons mentioned can be used as the solvent. Preference is given to solvent systems which have a boiling temperature of ≦100° C.

Solvents are used especially in the case of use of film formers.

The adhesion promoter composition may comprise further constituents. Such additional constituents are surfactants, acids, catalysts, biocides, antisettling agents, desiccants, stabilizers, pigments, dyes, anticorrosives, odorants, thixotropic agents, fillers, defoamers and the like.

The adhesion promoter composition may have one component or two components. For example, the adhesion promoter composition may be a two-component aqueous polyurethane dispersion.

The adhesion promoter composition described is suitable particularly as an undercoat, preferably as an undercoat for adhesives and/or sealants. Use of such an undercoat improves the adhesion. By virtue of the presence of at least one luminescent substance in the adhesion promoter composition, its use is suitable especially in the two cases which follow.

Firstly, a black undercoat on a black substrate can be detected in a very simple manner, specifically as described in detail below, before the adhesive bonding or sealing. Such a detection is important especially in order to guarantee a good quality of an adhesive bond or seal, since the presence of the adhesion promoter composition is of great significance therefor.

This is particularly important when the gloss of the black pigment-containing substrate and of the undercoat also differs only slightly, if at all. In particular, this method is also suitable for the cases where the ratio of the gloss values of the undercoat and of the black pigment-containing substrate is between 0.95 and 1.05, especially between 0.99 and 1.01. Gloss measurement is a test method known to the person skilled in the art, and can be measured, for example, by means of the Erichsen Pico-Glossmaster 500 or PicoGloss 503 gloss meter.

The most preferred black pigment-containing substrate is glass ceramic.

Secondly, in an adhesive bond which has already been produced, it is possible to determine in a simple manner whether a suitable adhesion promoter composition, if any at all, has been used. This is important especially in the case of damage, where it has to be assessed whether the damage is a material or application error, especially whether an application of an adhesion promoter composition which was stipulated for the process has not been done.

The adhesion promoter composition can be applied by means of a cloth, felt, roller, spray, sponge, brush, dip-coater or the like, and can be applied either manually or by means of robots.

The invention thus also embraces a method for adhesive bonding or for sealing. Especially the following three variants of this method are preferred.

The first variant comprises the steps of
i) applying an adhesion promoter composition as per the preceding description to a substrate S1 for adhesive bonding or for sealing;
ii) applying an adhesive or sealant to the flashed-off adhesion promoter composition present on the substrate S1;
iii) contacting the adhesive or sealant with a second substrate S2.

The second variant comprises the steps of
i′) applying an adhesion promoter composition as per the preceding description to a substrate S1 for adhesive bonding or for sealing;
ii′) applying an adhesive or sealant to the surface of a second substrate S2;
iii′) contacting the adhesive or sealant with the flashed-off adhesion promoter composition present on the substrate S2.

The third variant comprises the steps of
i″) applying an adhesion promoter composition as per the preceding description to a substrate S1 for adhesive bonding or for sealing;
ii″) flashing off the adhesion promoter composition;
iii″) applying an adhesive or sealant between the surfaces of substrates S1 and S2.

In all three variants, the second substrate S2 consists of the same material as or a different material than the substrate S1.

Typically, step iii), iii′) or iii″) is followed by a step iv) for hardening the adhesive or sealant.

Adhesives and sealants are very similar. Both need good adhesion on the substrate in order to fulfill their function optimally. In the case of the adhesives, the demands on the adhesion, or on the forces which have to be transmitted between substrate and adhesive, however, are even higher than for the sealants. Therefore, the adhesion promoter composition is used especially in the case of adhesives.

The adhesive used may in principle be any adhesive. Preference is given to using a moisture-curing adhesive, especially an adhesive which is cured by means of air humidity. Firstly, these are adhesives based on silane group-terminated polymers, as known to the person skilled in the art under the name “MS polymers”, or secondly adhesives based on silane group-terminated polyurethanes, as known to the person skilled in the art under the name “SPUR” (Silane Terminated Polyurethanes). The advantageous improvements in adhesion have, however, been found especially in the case of polyurethane adhesives or sealants, especially in the case of polyurethane adhesives which comprise polyurethane polymers having isocyanate groups. Such polyurethane adhesives are commercially widely available, especially under the names Sikaflex® or SikaTack® from Sika Schweiz AG.

Suitable adhesives based on isocyanate-terminated polymers are likewise understood to mean two-component polyurethane adhesives whose first component is an amine or a polyol and whose second component is a polymer containing isocyanate groups or a polyisocyanate. Examples of such two-component polyurethane adhesives which cure at room temperature are those from the SikaForce® product line, as commercially available from Sika Schweiz AG.

Suitable adhesives based on isocyanate-terminated prepolymers should also be understood to mean reactive polyurethane hotmelt adhesives which comprise a thermoplastic polymer and an isocyanate-terminated polymer or a thermoplastic isocyanate-terminated polymer. Such reactive polyurethane hotmelt adhesives are melted and either solidify in the course of cooling or crosslink through a reaction with air humidity. For example, such reactive polyurethane hotmelt adhesives are commercially available under the SikaMelt® name from Sika Schweiz AG.

The substrate S1 and/or S2 may be of various types. At least one of the substrates S1 or S2 is preferably a black pigment-containing substrate, especially a black pigment-containing plastic, preferably a black pigment-containing thermoplastic. More particularly, one of the substrates S1 or S2 may be glass ceramic, especially a black pigment-containing glass ceramic. In addition, one of the substrates S1 or S2 may be a coating material or a coated metal or a coated metal alloy.

Thermoplastic polymers, or thermoplastics, are in principle understood to mean plastics which soften and can be deformed within a particular temperature range, especially above the use temperature thereof. These thermoplastics can be deformed, for example, in an extruder.

Suitable thermoplastics are especially polyvinyl chloride, polycarbonates, polyurethanes, polybutylene 1,4-terephthalates, polyethylene terephthalates, polyamides, polyoxymethylenes, styrene-acrylonitriles, acrylonitrile-butadiene-styrenes, polymethyl (meth)acrylate, polystyrene, polypropylene, polyethylene and mixtures thereof. Especially suitable are polyvinyl chloride, polycarbonates and polyurethanes. Most preferred is polyvinyl chloride.

Especially polyethylene and polypropylene are known not to be very receptive to adhesive bonding. However, they can be modified with certain pretreatment methods in such a way that they are suitable for the purpose which exists here. Such pretreatment methods are especially gas phase fluorination or plasma pretreatments, especially plasma pretreatments under atmospheric pressure, as implemented, for example, in the OpenAir method of Plasmatreat GmbH, Germany.

In addition, the plastic can be produced, for example, via a reaction transfer molding (RTM) process or via a reaction injection molding (RIM) process from reactive polymer precursors. Such reactive polymer precursors suitable for this purpose are, for example, polyisocyanates, epoxy resins, polycarboxylic acids, unsaturated compounds such as (meth)acrylates, unsaturated polyesters or styrene. In the RTM or RIM process, these polymer precursors are hardened with an addition partner, especially polyamines, polyols or polymercaptans, or a free-radical former, especially peroxides.

The black pigment is introduced into the thermoplastic or the polymer precursor in a manner known to the person skilled in the art, and mixed. Such black pigment-containing thermoplastics can be shaped readily and are available in a wide variety as add-on components. The black pigment-containing plastics produced by the RTM or RIM process have the shape defined by the mold and can be used thus as installable or add-on components.

In one embodiment, the black pigment-containing substrate is a black primer.

Glass ceramics are understood to mean especially glass ceramics as typically applied in the edge region of motor vehicle panes. The construction and the production of such glass ceramics is known to the person skilled in the art, for example from Krause H., Keramische Farben [Ceramic Dyes] in ‘Ullmann’ Volume 14, (VCH Verlag, 4th edition, 1977), on pages 1-12.

In addition, the invention likewise embraces articles to which the adhesion promoter composition described has been applied by the method described. This article is preferably a built structure, especially a built structure in construction or civil engineering, or industrial goods or consumer goods, especially a window, a household appliance, or a mode of transport, especially a water or land vehicle, preferably an automobile, a bus, a truck, a train or a ship, or an add-on component of a mode of transport.

The invention further embraces a method for detecting the adhesion promoter composition described, comprising at least the steps of
a) irradiating a substrate coated with the adhesion promoter composition or an adhesive-bonded article with radiation of a particular wavelength λ₁, especially UV radiation, preferably radiation of wavelength of 240 to 400 nm;
b) detecting the radiation of wavelength λ₂ emitted by the luminescent substance, especially by means of a photodetector. The photodetector is preferably provided with an optical filter which retains the incident radiation with the wavelength λ₁ and transmits only the radiation with the wavelength λ₂ emitted by the luminescent substance in the adhesion promoter composition to the photodetector.

The method for detecting the adhesion promoter composition can be carried out in a manual method and/or in an automated method.

### DESCRIPTION OF THE DRAWINGS

Selected working examples of the invention are illustrated in detail hereinafter with reference to the drawings. Identical elements are provided with the same reference numerals in the different figures.

The figures show:

FIG. 1 a schematic cross section through a coated substrate in the detection method;

FIG. 2 a perspective schematic diagram of the detection method using the example of automotive glazing;

FIG. 3 a schematic diagram of a substrate with two applied undercoat strips before (FIG. 3a) and after (FIG. 3b) application of an adhesive bead;

FIG. 4a a diagram of the blue light emission of a glass ceramic coated with strips of adhesion promoter compositions of different concentrations of luminescent substance;

FIG. 4b a graph of the dependence of the intensity of light emission as a function of the concentration of the luminescent substance in the adhesion promoter composition:

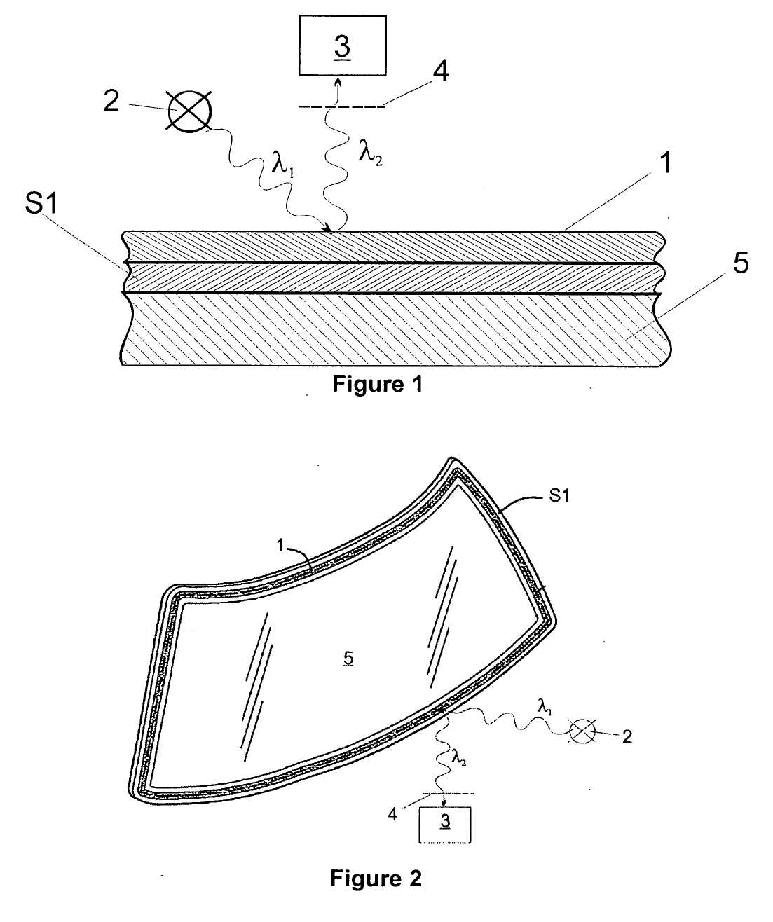

FIG. 1 shows a schematic of a cross section through a substrate S1 which is present on a carrier material 5 and is coated with an adhesion promoter composition 1. A detection method is carried out on this substrate S1, wherein the substrate S1 is irradiated by means of a radiation source 2 with radiation of wavelength λ₁ in the UV range. As a result of presence of a luminescent substance in the adhesion promoter composition 1, the latter emits radiation of wavelength λ₂ which is typically in the visible light range and can be detected by the eye or by means of a photodetector 3. Optionally, an optical filter 4 can be placed upstream of the photodetector, and more particularly filters out the radiation of the radiation source 2 with the wavelength λ₁ before the detection.

The detection method as shown in FIG. 1 allows a black undercoat on a black substrate to be made visible, or detectable.

FIG. 2 shows a perspective schematic diagram of a preferred application of the detection method shown in FIG. 1. In this application, automotive glazing 5 whose glass ceramic edge in this case constitutes the substrate S1 and which is coated with the adhesion promoter composition 1 is irradiated by means of a radiation source 2 with radiation of wavelength λ₁. As a result of the presence of a luminescent substance in the adhesion promoter composition 1, the latter in turn emits radiation of wavelength λ₂ which can be detected by eye or by means of a photodetector 3. As already shown in FIG. 1, it may be useful to place an optical filter 4 upstream of the photodetector 3.

By virtue of the application of the detection method as shown in FIG. 2, it is possible firstly to check whether the adhesion promoter composition has been applied at the site envisaged therefor on the substrate S1, in this case continuously on the edge region of the pane, and optimal adhesion can thus be ensured. Secondly, in the event of an undesired loss of adhesion properties, it is possible to check whether the stipulated adhesion promoter composition was applied as intended.

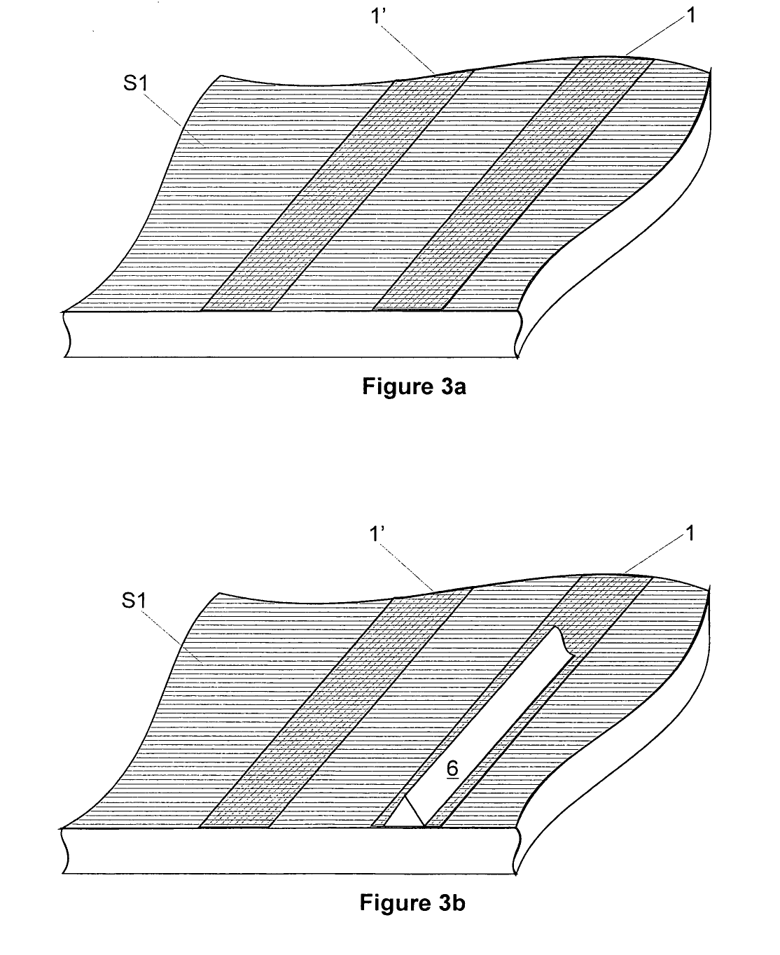

FIG. 3a shows a schematic perspective diagram of a substrate S1 to which two strips of the different adhesion promoter compositions 1 and 1′ have been applied. The adhesion promoter compositions 1 and 1′ are suitable for different adhesives and/or sealants and also differ to the extent that they contain different luminescent substances. As a result, both emit visible light after irradiation with UV radiation.

In a first variant, the adhesion promoter compositions 1 and 1′ comprise luminescent substances which, on excitation with UV radiation, emit very different wavelengths λ₁ and λ₁′ of visible light. For instance, the luminescent substance in the adhesion promoter composition 1 absorbs the wavelength λ₁, while the luminescent substance in the adhesion promoter composition 1′ cannot absorb this radiation of wavelength λ₁ and accordingly no emission proceeding from adhesion promoter composition 1′ is possible. In the event of irradiation of a substrate S1 with the applied adhesion promoter compositions 1 and 1′ with radiation of wavelength λ₁, only the adhesion promoter composition 1 is thus visible. When irradiation is effected with radiation of wavelength λ₁′, only the adhesion promoter composition 1′ absorbs this radiation, and therefore only this strip emits radiation. Thus, according to the selection of the excitation wavelength λ₁ or λ₁′, it is possible to identify the particular adhesion promoter composition 1 or 1′.

In a second, preferred variant, the sample is irradiated with a wavelength λ₁ and the luminescent substances in the two adhesion promoter compositions 1 and 1′ emit different wavelengths λ₂ and λ₂′, which can be distinguished from one another utilizing particular filters. Detection of the different emission wavelengths allows the adhesion promoter compositions 1 and 1′ to be distinguished from one another.

If it is assumed that the substrate S1 and the two adhesion promoter compositions 1 and 1′ contain black pigments, it is neither possible to detect the adhesion promoter compositions on the substrate S1 under normal daylight, nor would it be possible to distinguish the adhesion promoter compositions 1 and 1′ from one another. More particularly, no distinction is possible when the gloss value of the substrate S1 and that of the two adhesion promoter compositions differ only slightly, if at all.

After application of a detection method as described in FIG. 1 and FIG. 2, the strips with the different adhesion promoter compositions 1 and 1′ can, however, be distinguished from one another. In cases where different adhesives on different undercoats have to be applied alongside one another on the same substrate S1, such a detection method serves two purposes. Firstly, it is possible, for example, to make the black adhesion promoter composition 1 visible on the black substrate S1. Secondly, and as shown in FIG. 3c, it is possible to ensure that the adhesive 6 is applied to the adhesion promoter composition 1 which is suitable and envisaged therefor, and not to the adhesion promoter composition 1′ which is unsuitable therefor. Thus, confusion is substantially ruled out and a reliable adhesive bond is ensured.

The detection method, as described here in particular in FIG. 2, can optionally be carried out with partial or full automation. This is preferred in cases where the method is used to check whether the adhesion promoter composition has been applied at the site envisaged therefor on the substrate S1, in the case of FIG. 2 continuously on the edge region of the motor vehicle pane. The application of the adhesion promoter composition 1, the detection and the subsequent application of the adhesive or sealant can be effected in immediate succession. This can be supported by suitable software for image capture and/or for robot control in the application of the undercoat and/or of the adhesive or sealant.

The detection method can preferably be carried out during the open time of the adhesion promoter composition 1 and before the application of the adhesive or sealant. This makes it possible to recognize substrates, such as motor vehicle panes, which have received an inadequate undercoat within a production line process and to exclude them before the adhesive is applied thereto. This is particularly advantageous because this allows the unnecessary use of adhesive to be reduced.

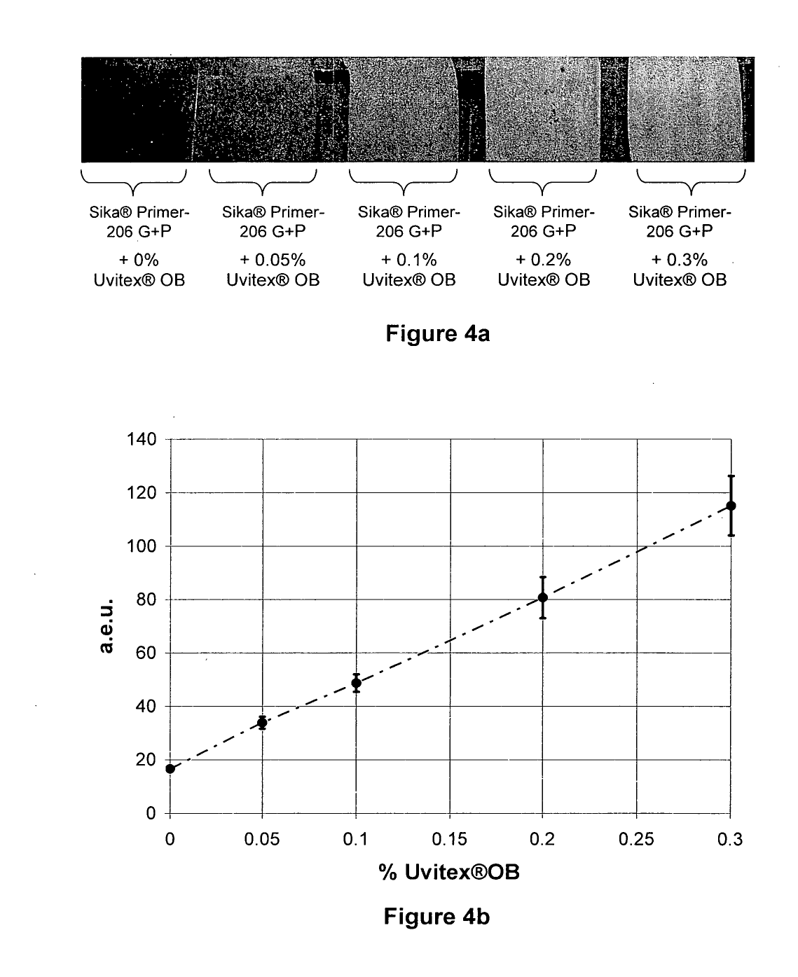

For FIGS. 4a and 4b, different concentrations of Uvitex® OB, commercially available from Ciba Specialty Chemicals, were prepared as a 5% solution in xylene. Subsequently, the solution was added in the appropriate dosage to the Sika® primer 206 G+P, and mixed in by means of a dissolver under nitrogen, so as to obtain adhesion promoter compositions with Uvitex® OB concentrations of 0.05% by weight, 0.1% by weight, 0.2% by weight and 0.3% by weight. Sika® Primer-206 G+P contains between 7 and 10% by weight of carbon black.

The black adhesion promoter compositions thus produced were applied alongside one another as strips with a doctorblade in a layer thickness of 40 μm on a glass ceramic test specimen from Rocholl GmbH, Germany. On the same substrate, a strip with Sika® Primer-206 G+P without luminescent substance was additionally applied as a reference (blank sample). The black strips on the black glass ceramic are discernible only with very great difficulty, if at all, under daylight.

Subsequently, the sample was irradiated with UV light of wavelength between 360 and 380 nm, and photographed with a Nikon E4300 digital camera (exposure time 1/15 s, ISO speed ISO-400, F/2.8). The resulting digital photograph was separated into the RGB channels with the aid of the Corel® Photo-Paint 11.0 image processing software from Corel® UK Limited. The diagram in FIG. 4a is that of the blue channel.

FIG. 4b shows a graph of the dependence of the intensity of light emission as a function of the concentration of the luminescent substance in the adhesion promoter composition.

To this end, the above-described glass ceramic test specimen with the strips of adhesion promoter compositions of different Uvitex® OB concentrations was studied by means of a microscope. The sample was irradiated under a microscope (Olympus BX51M, object lens 5×, camera attachment to CCD camera with 2048×1536 pixels) with UV light of wavelengths 420-440 nm by means of an Hg vapor lamp, and the emission was observed at wavelengths of >475 nm. Sections of approx. 0.4×0.4 mm of the images of the corresponding adhesion promoter composition strips were used in each case for the quantitative analysis. The average intensity value of the blue channel for such an image section was determined by means of image analysis. 45 intensity values of the blue channel per concentration were thus averaged from five images with nine such sections in each case, and the standard deviation of these values was determined. The mean intensity value (a.e.u.=arbitrary emission unit) of the blue channel of a sample was plotted against the particular Uvitex® OB concentration to find a linear relationship with a correlation coefficient of r²=0.9991.

The results of these tests illustrated in FIGS. 4a and 4b show that adhesion promoter compositions filled with a black pigment, specifically with carbon black, can be detected or distinguished in a simple manner on a black substrate, specifically a black glass ceramic.

### LIST OF REFERENCE NUMERALS

1, 1′ Adhesion promoter composition with luminescent substance
2 Radiation source
3 Photodetector
4 Optical filter
5 Carrier material
6 Adhesive bead
S1 Substrate 1
λ₁, λ₁′ Radiations of two particular wavelengths
λ₂, λ₂′ Radiations of two different wavelengths

1. An adhesion promoter composition comprising
at least one adhesion-promoting substance;
at least one black pigment;
at least one luminescent substance.

2. The adhesion promoter composition as claimed in claim 1, wherein the adhesion-promoting substance is selected from the group consisting of organosilicon compounds, organotitanium compounds, organozirconium compounds, polyepoxides, polyisocyanates and isocyanate-containing polymers.

3. The adhesion promoter composition as claimed in claim 2, wherein the adhesion-promoting substance is an organosilicon compound.

4. The adhesion promoter composition as claimed in claim 2, wherein the adhesion-promoting substance is a polyisocyanate.

5. The adhesion promoter composition as claimed in claim 1, wherein the black pigment is selected from the group consisting of carbon black, iron oxide black, chromium iron black, iron manganese copper oxide, aniline black, anthraquinone pigments and perylene pigments.

6. The adhesion promoter composition as claimed in claim 1, wherein the proportion of black pigment is 0.1-15% by weight, of the overall adhesion promoter composition.

7. The adhesion promoter composition as claimed in claim 1, wherein the total weight of adhesion-promoting substance and black pigment is ≧10% by weight, of the overall adhesion promoter composition.

8. The adhesion promoter composition as claimed in claim 1, wherein the adhesion promoter composition additionally comprises at least one solvent.

9. The adhesion promoter composition as claimed in claim 1, wherein the proportion of luminescent substance is 0.01-5% by weight, of the overall adhesion promoter composition.

10. An undercoat for adhesives and/or sealants comprising an adhesion promoter composition as claimed in claim 1.

11. A substrate coated with an adhesion promoter composition as claimed in claim 1, wherein the substrate is a black pigment-containing substrate.

12. A coated substrate as claimed in claim 11, wherein the substrate is glass ceramic.

13. A method for adhesive bonding or for sealing, comprising the steps of:
i) applying an adhesion promoter composition as claimed in claim 1 to a substrate S1 for adhesive bonding or for sealing; and
ii) applying an adhesive or sealant to the flashed-off adhesion promoter composition present on the substrate S1;
iii) contacting the adhesive or sealant with a second substrate S2;
or
i′) applying an adhesion promoter composition as claimed in claim 1 to a substrate S1 for adhesive bonding or for sealing;
ii′) applying an adhesive or sealant to the surface of a second substrate S2; and
iii′) contacting the adhesive or sealant with the flashed-off adhesion promoter composition present on the substrate S1;
or
i″) applying an adhesion promoter composition as claimed in claim 1 to a substrate S1 for adhesive bonding or for sealing;
ii″) flashing off the adhesion promoter composition; and
iii″) applying an adhesive or sealant between the surfaces of substrates S1 and S2;
the second substrate S2 consisting of the same material or a different material than substrate S1.

14. The method as claimed in claim 13, wherein step iii), iii′) or iii″) is followed by a step iv) for hardening the adhesive or sealant.

15. The method as claimed in claim 13 wherein the substrate S1 is a black pigment-containing substrate.

16. The method as claimed in claim 15, wherein the substrate S2 is a coating material or a coated metal or a coated metal alloy.

17. An article which has been adhesive bonded by a method as claimed in claim 13.

18. The article as claimed in claim 17, wherein the article is a built structure, or industrial goods or consumer goods, a household appliance, or a mode of transport, or an add-on component of a mode of transport.

19. A method for detecting an adhesion promoter composition as claimed in claim 1 on a substrate, comprising the steps of
a) irradiating the substrate (S1) coated with an adhesion promoter composition with radiation of wavelength λ₁ of 240 to 400 nm;
b) detecting the radiation of wavelength λ₂ emitted by the luminescent substance, with a photodetector.

20. The method as claimed in claim 19, wherein an optical filter is arranged between the photodetector and the adhesion promoter composition, and absorbs the radiation of wavelength λ₁.
